(19) United States
(12) Patent Application Publication
(10) Pub. No.: US 2003/0106399 A1
(43) Pub. Date: Jun. 12, 2003

(54) Lathe for tooling a wood workpiece

(75) Inventors: Juei-Seng Liao, Taichung City (TW); Pei-Lieh Chiang, Taichung City (TW)

Correspondence Address: LADAS & PARRY, 26 West 61st Street, New York, NY, 10023-7604, US

(73) Assignees: JUEI-SENG LIAO; PEI-LIEH CHIANG

(21) Appl. No.: 09/996,542

(22) Filed: Nov. 28, 2001

(30) Foreign Application Priority Data
Oct. 15, 2001 (TW) 090217525

(51) Int. Cl. B23B 3/00; B23B 25/00

(52) U.S. Cl. 82/117; 82/142

(57) ABSTRACT

A lathe for tooling a wood workpiece includes a shaving collecting member disposed proximate to a tool rest. A drive transmission member transmits the rotating force of work spindle to a drive shaft so as to rotate an impeller mounted in an accommodation chamber of a casing. The shaving collecting member has a duct communicated with the accommodation chamber such that wood shavings are drawn from the duct into the accommodation chamber and out of a discharge port of the casing during a wood-cutting operation of the lathe.

### CROSS-REFERENCE TO RELATED APPLICATION

This application claims priority of Taiwan patent Application No. 090217525, filed on Oct. 15, 2001.

### BACKGROUND OF THE INVENTION

1. Field of the Invention

This invention relates to a lathe for tooling a wood workpiece, more particularly to a lathe with a wood shaving collecting mechanism which is driven by a motor thereof.

2. Description of the Related Art

Referring to FIGS. 1 and 2, a conventional lathe 10 is shown to include a bed 11, a headstock 12, a tail-stock (not shown), and a tool rest 13 between the headstock 12 and the tail-stock. The headstock 12, the tail-stock and the tool rest 13 are mounted on the bed 11. A motor 15 is mounted in the headstock 12 and delivers a driving force which is transmitted to a work spindle 16 by a drive transmission member 18. The drive transmission member 18 includes a drive pulley 182 mounted on and rotatable with an output shaft of the motor 15, a driven pulley 181 mounted on a transmitting shaft 17 that is coupled to the work spindle 16, a belt 183 trained on the drive and driven pulleys 182, 181 to transmit the driving force to the transmitting shaft 17, thereby rotating the work spindle 16 to rotate a wood workpiece held thereon. A control member 19 is mounted to adjust the rotation speed of the work spindle 16. Since a large amount of wood shavings is formed and scatters during a wood-cutting operation of the lathe 10, collecting means is needed to collect the wood shavings.

### SUMMARY OF THE INVENTION

The object of the present invention is to provide a lathe for tooling a wood workpiece which has a wood shaving collecting mechanism to collect wood shavings during a wood-cutting operation of the lathe.

According to this invention, the lathe includes a bed, a headstock, a tail-stock spaced apart from the headstock in a longitudinal direction to define a tooling area therebetween where a wood workpiece is worked, and a tool rest movably mounted on the bed to carry and bring a tool to extend into the tooling area so as to work on the wood workpiece. A motor is disposed in the headstock, and has an output shaft to deliver a driving force. A work spindle is rotatably mounted in the headstock and extends in the longitudinal direction. The work spindle is disposed to be driven by the driving force of the output shaft to have a rotating force so as to rotate the wood workpiece about a first axis in the tooling area, thereby permitting the wood workpiece to be worked by the tool. A shaving collecting member is disposed proximate to the tool rest, and includes a duct which has an intake port to be disposed in the vicinity of the tool, and an outlet port disposed opposite to the intake port. A casing has proximate and distal walls which are spaced apart from each other in the longitudinal direction and which are respectively proximate and distal to the outlet port to confine an accommodation chamber. The casing further has a discharge port which is disposed between the proximate and distal walls and which extends in a direction radial to the longitudinal direction. The proximate wall has an inlet port which is formed therethrough in the longitudinal direction and which is communicated with the outlet port so as to communicate the duct with the accommodation chamber. A drive shaft is rotatably mounted on the distal wall, extends along a second axis parallel to the first axis, and has a first end which extends into the accommodation chamber, and a second end which extends from the first end and outwardly of the distal wall. A drive transmission member is disposed to transmit the rotating force of the spindle to rotate the second end of the drive shaft, thereby turning the drive shaft about the second axis when the motor is operated. An impeller is received in the accommodation chamber, and is driven by the first end of the drive shaft to rotate about the second axis. Thus, wood shavings are drawn from the shaving collecting member into the accommodation chamber and out of the discharge port.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a portion of a conventional lathe for tooling a wood workpiece;

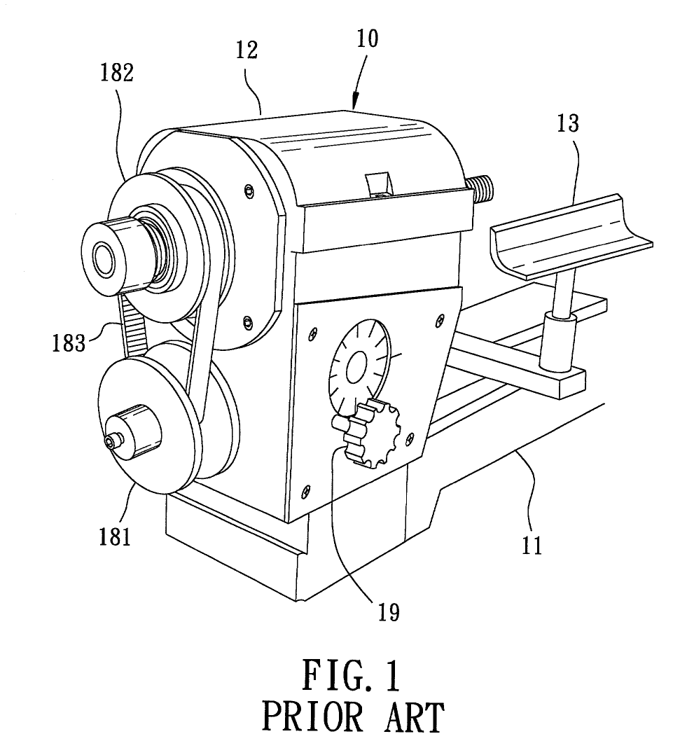

FIG. 2 is a sectional view of a portion of the conventional lathe;

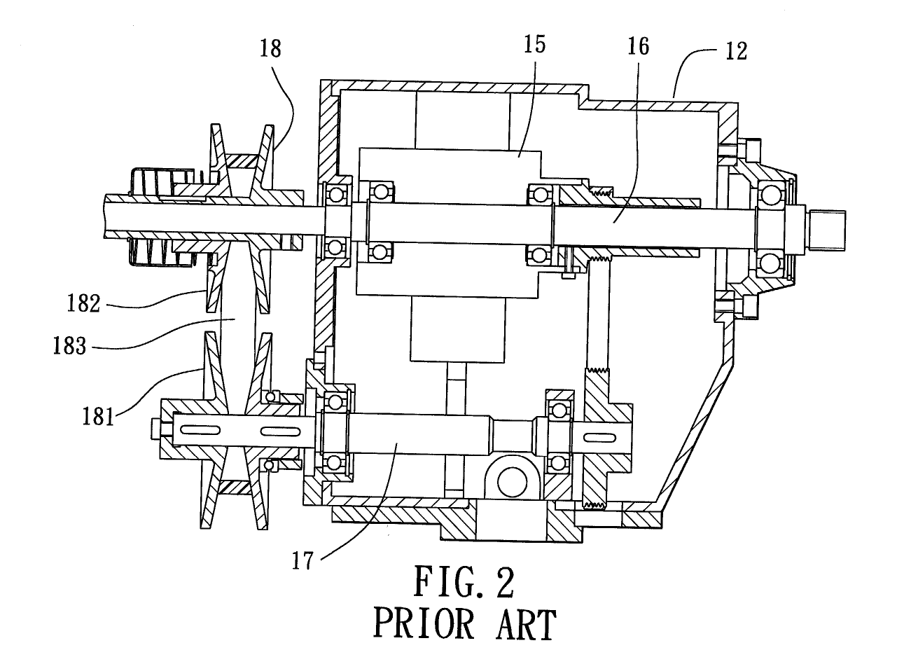

FIG. 3 is a perspective view of a first preferred embodiment of a lathe according to this invention;

FIG. 4 is a perspective view of a portion of the first preferred embodiment;

FIG. 5 is an exploded perspective view of a shaving collecting mechanism of the first preferred embodiment;

FIG. 6 is a perspective view illustrating the shaving collecting mechanism mounted on a tool rest of the first preferred embodiment;

FIG. 7 is a perspective view illustrating the shaving collecting mechanism mounted on a headstock of the first preferred embodiment;

FIG. 8 is a sectional view showing components in the headstock of the first preferred embodiment;

FIG. 9 is a fragmentary schematic view showing the flow of wood shavings in the shaving collecting mechanism;

FIG. 10 is a perspective view of a portion of a second preferred embodiment of this invention;

FIG. 11 is a perspective view illustrating a shaving collecting mechanism mounted on a tool rest of the second preferred embodiment; and

FIG. 12 is an exploded perspective view similar to FIG. 11.

### DETAILED DESCRIPTION OF THE PREFERRED EMBODIMENTS

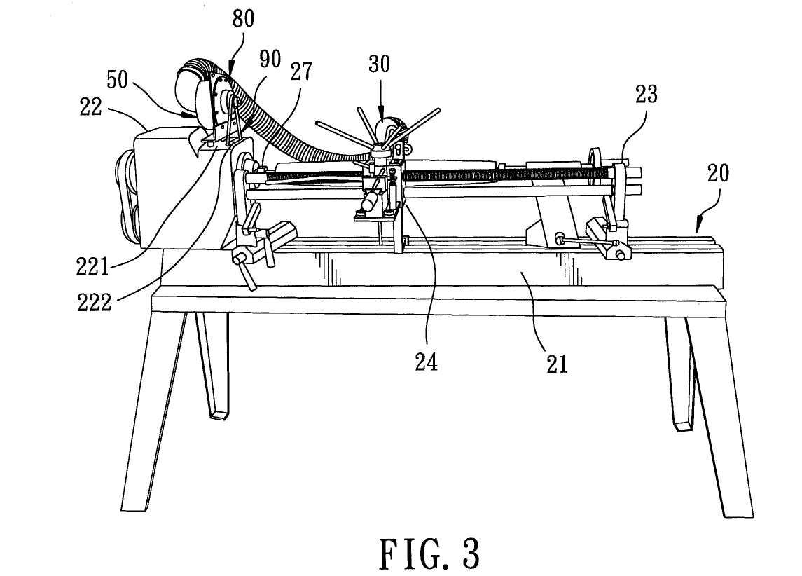

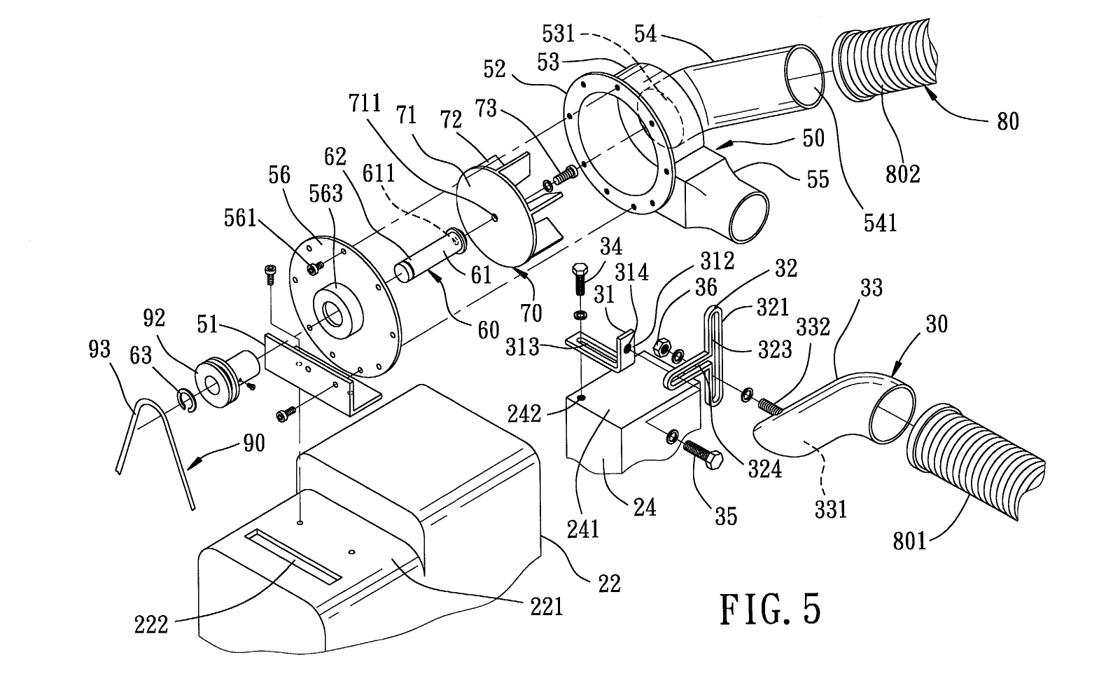

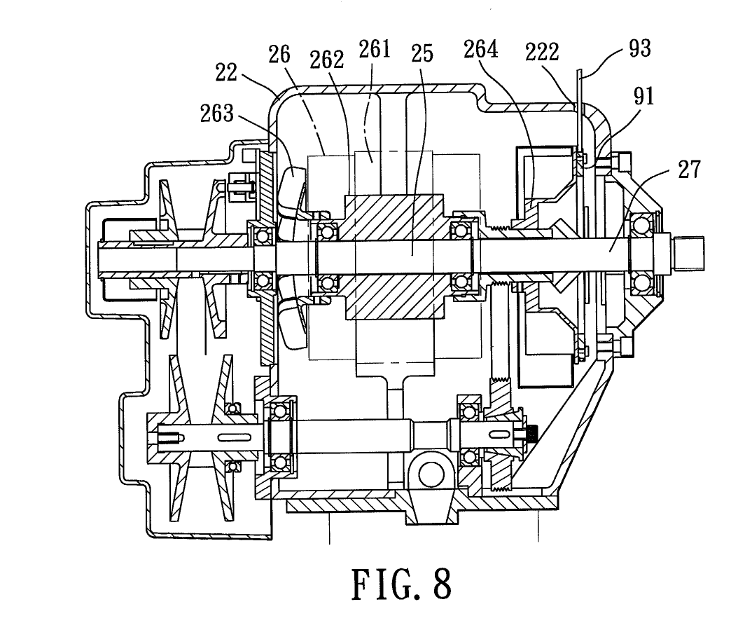

Referring to FIGS. 3, 4 and 5, the first preferred embodiment of the lathe 20 for tooling a wood workpiece (not shown) according to the present invention is shown to comprise a bed 21, a headstock 22, a tail-stock 23 which is spaced apart from the headstock 22 in a longitudinal direction to define a tooling area therebetween where the wood workpiece is worked, and a tool rest 24 which is movably mounted on the bed 21 to carry and bring a tool (not shown) to extend into the tooling area so as to work on the wood workpiece. As shown in FIGS. 5 and 8, the headstock 22 includes a top wall 221 with an elongate slot 222 formed therethrough. A motor 26 is disposed in the headstock 22, and includes a stator 261, and a rotor 262 which is rotatably mounted in the stator 261 and which has an output shaft 25 to deliver a driving force, and two radiator fans 263, 264 which are mounted at two ends of the rotor 262. A work spindle 27 is rotatably mounted in the headstock 22 and extends in the longitudinal direction. The work spindle 27 is disposed to be driven by the driving force of the output shaft 25 in a known manner to have a rotating force so as to rotate the wood workpiece about a first axis in the tooling area, thereby permitting the wood workpiece to be worked by the tool.

The lathe further comprises a shaving collecting mechanism which includes a shaving collecting member 30, a casing 50, a drive shaft 60, a drive transmission member 90, and an impeller 70.

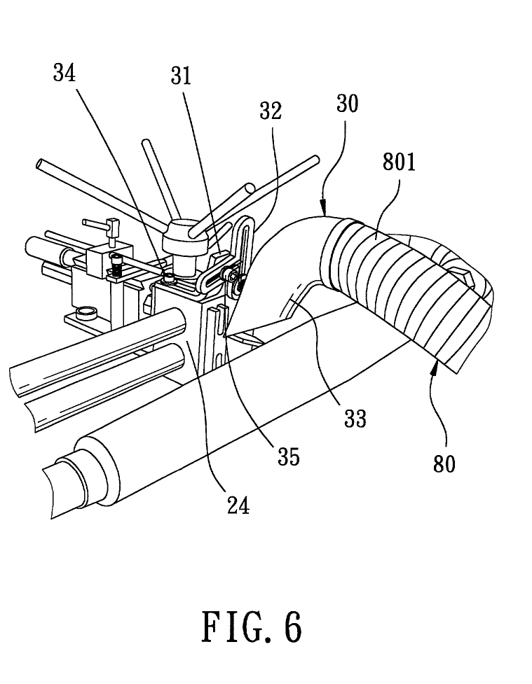

With reference to FIGS. 5 and 6, the shaving collecting member 30 includes an L-shaped positioning member 31 which is adjustably secured on a top wall 241 of the tool rest 24 by means of a screw fastener 34 passing through an elongate hole 313 and threadedly engaging a screw hole 242 in the top wall 241. A T-shaped adjusting member 32 is adjustably secured to an upright portion 312 of the positioning member 31 by means of a screw fastener 35 passing through an elongate hole 324 and engaging threadedly a screw hole 314 in the upright portion 312. A rigid head tube 33 forms an intake port 331, and has a screw bolt portion 332 which passes through an elongate hole 323 in an upright portion 321 of the adjusting member 32 and which engages threadedly a screw nut 36 to adjustably secure the head tube 33 to the adjusting member 32. Thus, the position of the head tube 33 relative to the tool rest 24 is adjustable in the longitudinal direction and in transverse and radial directions upon releasing the screw fasteners 34, 35 and the screw nut 36. A flexible tubular member 80 is connected to the head tube 33 at one end 801 thereof.

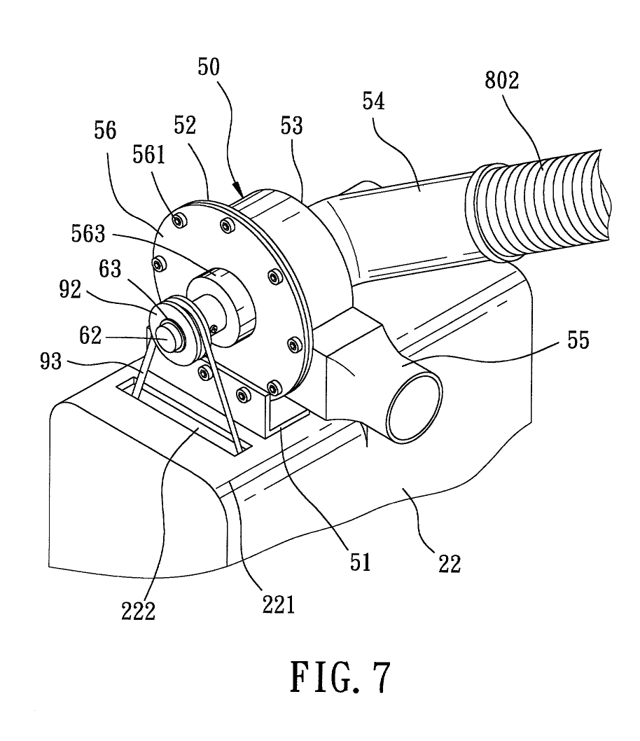

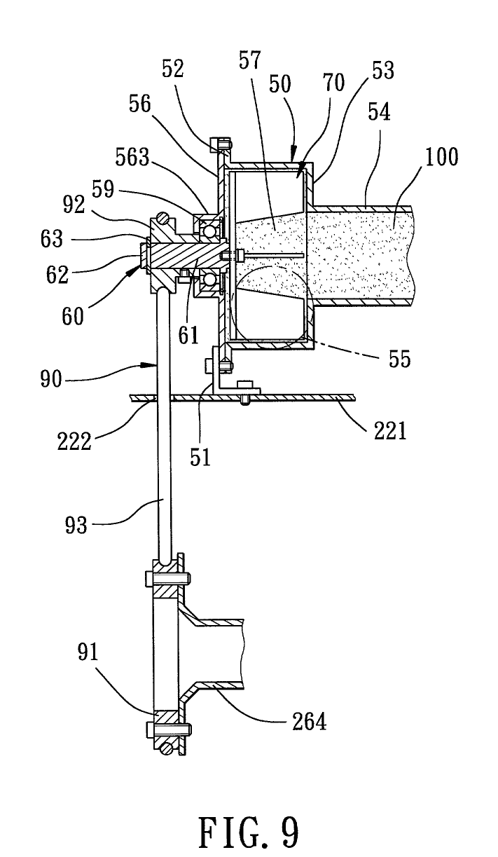

With reference to FIGS. 7 and 9, the casing 50 includes an axial tube 54 which is connected to the other end 802 of the tubular member 80 to form an outlet port 541 so as to cooperate with the tubular member 80 and the head tube 33 to confine a duct. The casing 50 further includes proximate and distal walls 53, 52 which are spaced apart from each other in the longitudinal direction and which are respectively proximate and distal to the outlet port 541 to confine an accommodation chamber 57. A cover plate 56 is secured on the distal wall 52 by means of screws 561, and has a bearing seat 563 for receiving a bearing 59 therein. The cover plate 56 is secured to the top wall 221 of the headstock 22 by an L-shaped positioning plate 51 so as to position the casing 50 relative to the headstock 22. The casing 50 further has a discharge port 55 which is disposed between the proximate and distal walls 53, 52 and which extends in a direction radial to the longitudinal direction. The proximate wall 53 has an inlet port 531 which is formed therethrough in the longitudinal direction and which is communicated with the outlet port 541 so as to communicate the duct with the accommodation chamber 57.

The drive shaft 60 is rotatably mounted on the cover plate 56 by means of the bearing 59, and extends along a second axis parallel to the first axis of the work spindle 27. The drive shaft 60 has a first end 61 which extends into the accommodation chamber 57 via the bearing seat 563, and a second end 62 which extends from the first end 61 and outwardly of the bearing seat 563.

As shown in FIGS. 7 to 9, the drive transmission member 90 includes a drive pulley 91 which is mounted on and which is rotated synchronously with the work spindle 27, a driven pulley 92 which is mounted on and which is rotated with the second end 62 of the drive shaft 60 by means of a snap ring 63, and a belt 93 which passes through the elongate slot 222 and which is trained on the drive and driven pulleys 91, 92 so as to transmit the rotating force of the work spindle 27 to the drive shaft 60, thereby turning the drive shaft 60 about the second axis when the motor 26 is operated.

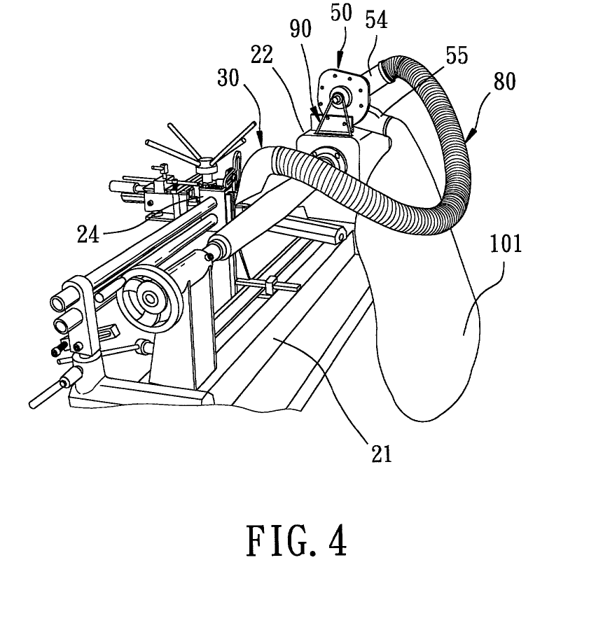

As shown in FIGS. 5 and 9, the impeller 70 is received in the accommodation chamber 57, and includes a connecting plate 71 which is secured on the first end 61 of the drive shaft 60 by a screw 73 that passes through a hole 711 and that engages threadedly a screw hole 611 in the first end 61 so as to be driven by the first end 61 to rotate a plurality of fins 72 on the connecting plate 71 about the second axis. Thus, when the motor 26 is actuated during a wood-cutting operation, wood shavings 100 can be drawn from the duct of the shaving collecting member 30 into the accommodation chamber 57 and out of the discharge port 55. Preferably, referring to FIG. 4, a shaving bag 101 is disposed to be connected to the discharge port 55.

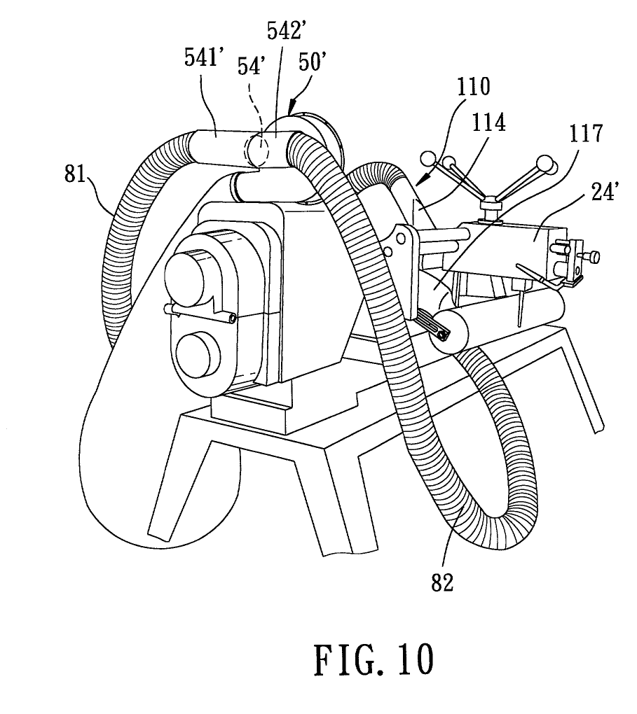

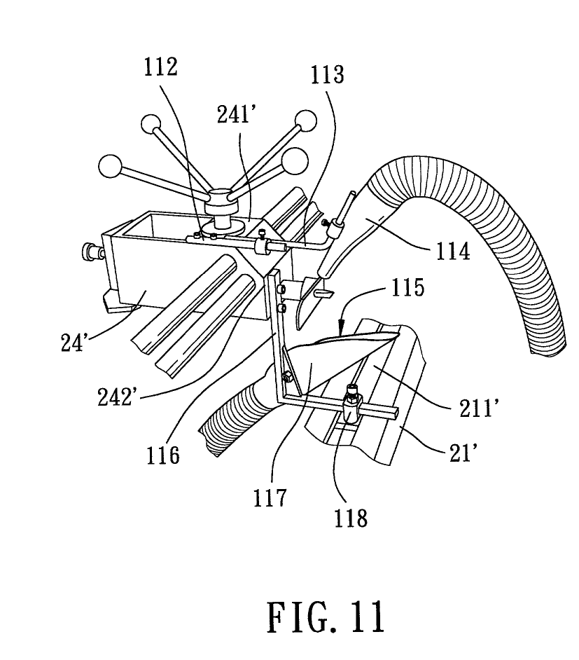

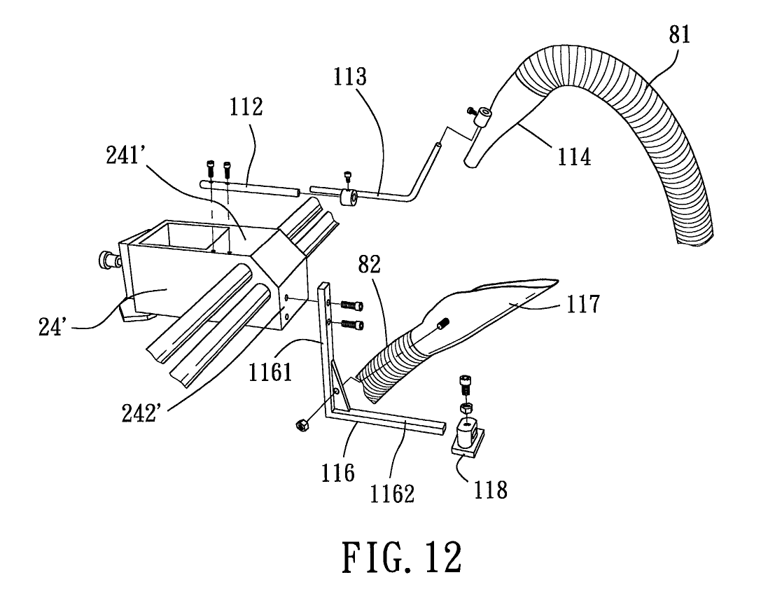

Alternatively, referring to FIGS. 10 to 12, the second preferred embodiment of the lathe according to this invention is shown to have a shaving collecting member 110 which includes first and second head tubes 114, 117 to form two intake port portions. The first head tube 114 is adjustably secured to a connecting sleeve 113 which is detachably secured to a positioning rod 112 that in turn is secured on a top wall 241′ of a tool rest 24′. The second head tube 117 is secured to an L-shaped positioning plate 116 which has one end portion 1161 secured on a side wall 242′ of the tool rest 24′, and the other end portion 1162 slidably secured to a bed 21′ by the sliding movement of a sliding block 118 along a sliding groove 211′. The shaving collecting member 110 further includes two flexible tubes 81, 82 which are respectively connected to the first and second head tubes 114, 117. The flexible tubes 81, 82 are further connected to first and second rigid tubes 541′, 542′ to form two outlet port portions which are communicated with an inlet port 54′ of a casing 50′ that is similar in construction to the casing 50 in the first preferred embodiment. Each of the head tubes 114, 117, each of the flexible tubes 181, 82 and each of the rigid tubes 541′, 542′ confine a conduit which is communicated with the accommodation chamber of the casing 50′.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

We claim:

1. A lathe for tooling a wood workpiece, comprising a bed, a headstock, a tail-stock spaced apart from said headstock in a longitudinal direction to define a tooling area therebetween where the wood workpiece is worked, and a tool rest movably mounted on said bed and adapted to carry and bring a tool to extend into the tooling area so as to work on the wood workpiece, said lathe further comprising:
a motor disposed in said headstock, and having an output shaft to deliver a driving force;
a work spindle rotatably mounted in said headstock and extending in the longitudinal direction, said work spindle being disposed to be driven by the driving force of said output shaft to have a rotating force so as to rotate the wood workpiece about a first axis in the tooling area, thereby permitting the wood workpiece to be worked by the tool;
a shaving collecting member disposed proximate to said tool rest, and including a duct which has an intake port adapted to be disposed in the vicinity of the tool, and an outlet port disposed opposite to said intake port;
a casing having proximate and distal walls which are spaced apart from each other in the longitudinal direction and which are respectively proximate and distal to said outlet port to confine an accommodation chamber, said casing further having a discharge port which is disposed between said proximate and distal walls and which extends in a direction radial to the longitudinal direction, said proximate wall having an inlet port which is formed therethrough in the longitudinal direction and which is communicated with said outlet port so as to communicate said duct with said accommodation chamber;
a drive shaft rotatably mounted on said distal wall, extending along a second axis parallel to the first axis, and having a first end which extends into said accommodation chamber, and a second end which extends from said first end and outwardly of said distal wall;
a drive transmission member disposed to transmit the rotating force of said spindle to rotate said second end of said drive shaft, thereby turning said drive shaft about the second axis when said motor is operated; and
an impeller received in said accommodation chamber, and driven by said first end of said drive shaft to rotate about the second axis such that wood shavings are drawn from said shaving collecting member into said accommodation chamber and out of said discharge port.

2. The lathe of claim 1, wherein said shaving collecting member includes a tubular member interconnecting said intake port and said outlet port to confine said duct.

3. The lathe of claim 2, further comprising a positioning member secured on said tool rest, said intake port being formed as a head tube disposed to be anchored to said positioning member.

4. The lathe of claim 3, wherein said positioning member is detachably and adjustably secured to said tool rest such that the position of said head tube relative to the tool is adjustable in a radial direction.

5. The lathe of claim 3, wherein said head tube is detachably and adjustably secured to said positioning member such that the position of said head tube relative to the tool is adjustable in the longitudinal direction.

6. The lathe of claim 1, wherein said drive transmission member includes a drive pulley mounted on and rotatable with said spindle, a driven pulley mounted on and rotatable with said second end of said drive shaft, and a belt trained on said drive and driven pulleys so as to transmit the rotating force of said spindle to said drive shaft.

7. The lathe of claim 1, wherein said duct includes two conduits which respectively have two intake port portions defining said intake port, and two outlet port portions defining said outlet port.

8. The lathe of claim 7, wherein said shaving collecting member includes two flexible tubes, each of which interconnects said intake port portion and said outlet port portion of a respective one of said conduits.

9. The lathe of claim 8, further comprising two positioning members secured on said tool rest, each of said intake port portions being formed as a head tube disposed to be anchored to a respective one of said positioning members.
